(19) United States
(12) Patent Application Publication
(10) Pub. No.: US 2016/0063901 A1
(43) Pub. Date: Mar. 3, 2016

(54) ELECTRONIC LABELLING DEVICE

(71) Applicant: STORE ELECTRONIC SYSTEMS, Argenteuil (FR)

(72) Inventor: Bernard Joliey, Saint-Raphael (FR)

(21) Appl. No.: 14/784,090

(22) PCT Filed: Apr. 2, 2014
(86) PCT No.: PCT/FR2014/050788

§ 371 Date: Oct. 13, 2015

(30) Foreign Application Priority Data
Apr. 17, 2013 (FR) 1353469

(51) Int. Cl. G09F 3/20

(52) U.S. Cl. CPC G09F 3/208; G09F 3/204

(57) ABSTRACT

The invention relates to an electronic labelling device formed by a label holder and an electronic label. The front portion (4) of the label holder includes a substantially flat front face (6) comprising an elastically deformable omega-shaped groove (7) intended to receive an omega-shaped rib belonging to the label.

The invention relates to an electronic labeling device and more particularly to an individual electronic labeling device particularly suited to the field of perfumery, cosmetics, pharmacy or parapharmacy.

In this field, the shelves are often narrow, the space available for products is limited, and the product locations frequently change. It is therefore necessary to provide a labeling device that is small in size, to simplify the operation of attaching and detaching the electronic labels, to fit the labels onto the fronts of the shelves quickly, and to position the labels correctly with respect to the label holders.

It is an object of the invention to propose an electronic labeling device that meets these requirements.

The subject of the invention is an electronic labeling device consisting of a label holder and of an electronic label ; the label holder comprising a rear part able to be fixed to the edge of a shelf, a front part able to accept an electronic label, and a flexible hinge to articulate the front part to the rear part; the electronic label on its from face bearing the display elements; characterized in that the front part of the label holder has a substantially flat front face comprising an elastically deformable omega-shaped groove, and in that the electronic label on its rear face bears an omega-shaped rib that can be inserted into the groove to fix the electronic label on the label holder.

Advantageously the dimensions of the rib correspond. to those of the groove.

Advantageously, at the two ends of the rib, the electronic label has two end-plates that guide the rib into the groove and hold the electronic label in place by collaborating with the vertical edges of the from part of the label holder.

Further features, details and advantages of the invention will become apparent from the following description with reference to the attached drawings in which:

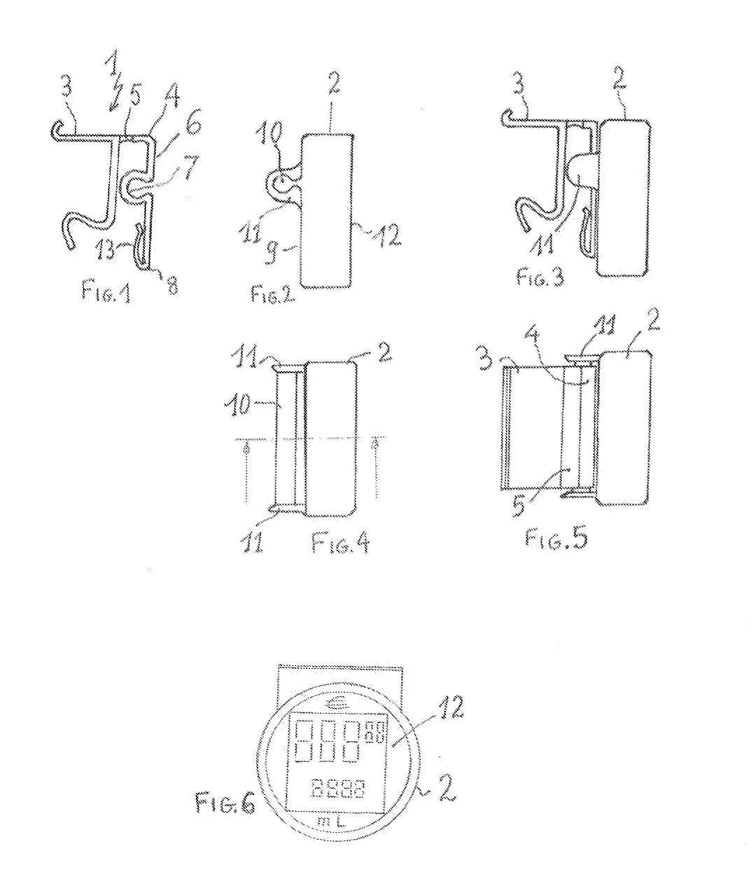

FIG. 1 is a side view of a label holder that forms part of the electronic labeling device according to the invention;

FIG. 2 is a view in section on the plane of symmetry of the electronic label that forms part of the electronic labeling device according to the invention;

FIG. 3 is a side view of the electronic labeling device according to the invention, in position of use;

FIG. 4 is a plan view of the electronic label of FIG. 2;

FIG. 5 is a plan view of the electronic labeling device of FIG. 3;

FIG. 6 is a front view of one particular embodiment of the electronic labeling device with a cylindrical label.

The electronic labeling device according to the invention is made up of a label holder 1 and of an electronic label 2. The label holder 1 is made up of a rear part 3, of a front part 4 and of a flexible hinge 5 for articulating the front part 4 to the rear part 3. The rear part 3 is a profile section designed to be fixed to the edge of a shelf, directly or via a rail on which it fastens, in the known way. The front part 4 is a profile section having a substantially flat front face 6 comprising an omega-shaped longitudinal groove 7. The rear part of the groove 7 more or less presses against the rear part 3 of the label holder 1. The groove 7 is elastically deformable, notably via horizontal pressure on the lower edge 8 of the front face 6, so that the opening of the groove 7 can be enlarged.

The electronic label 2 has the shape of a rectangular parallelepiped (FIGS. 2 to 5) or of a cylinder (FIG. 6) and on its rear face 9 bears an omega-shaped rib 10 the dimensions of which correspond to those of the groove 7 of the label holder 1, so that the rib 10 can be inserted into the groove 7.

The length of the rib 10 corresponds to that of the groove 7. At the two ends of the rib 10, the electronic label 2 bears two end-plates 11 intended to provide the rib 10 with lateral guidance as it is inserted into the groove 7, through collaboration with the vertical edges of the front part 4 of the label holder 1. In the conventional way, the front face 12 of the electronic label 2 bears the usual display elements.

For preference, the front part 4 of the label holder at its lower edge 8 bears a tab 13 which is bent over upwards and able to accept a bracket for keeping the electronic label in an inclined position. Keeping the electronic label inclined in this way is desirable when the electronic label is placed on a low shelf.

Once the label holder 1 has been fitted onto the edge of the shelf, the electronic label 2 is offered up with its rib 10 facing the groove 7. The end-plates 11 guide the electronic label 2 with respect to the vertical edges of the front part 4 of the label holder 1. Manual pressure on the electronic label 2 is enough to deform the groove 7 elastically and enlarge the opening thereof so that the rib 10 can pass through. This elastic deformation is made all the easier by pressure on the lower part of the electronic label 2 which causes the lower edge 8 of the front face 6 of the label holder to move back and enlarges the opening of the groove 7. Once the rib 10 is in the groove 7, the electronic label 2 is fixed to the label holder 1 and held in place by collaboration of the end-plates 11 with the vertical edges of the front part 4 of the label holder 1.

The electronic label 2 is removed by manual pressure on the lower part of the label to enlarge the opening of the groove 7 and by simultaneously pulling manually on the upper part of the electronic label 2 in order to extract the rib 10 from the groove 7. These operations of inserting and extracting the rib 10 are simple and quick and require no specialist tool.

1. An electronic labeling device comprising:
a label holder; and
an electronic label;
wherein the label holder has a rear part able to be fixed to the edge of a shelf, a front part able to accept an electronic label, and a flexible hinge to articulate the front part to the rear part; and
wherein the electronic label on its front face bearing the display elements; the front part of the label holder having a substantially flat front face with an elastically deformable omega-shaped groove, and in that the electronic label on its rear face bears an omega-shaped rib that can be inserted into the groove to fix the electronic label on the label holder.

2. The electronic labeling device as claimed in claim 1, wherein the dimensions of the rib correspond to those of the groove.

3. The electronic labeling device as claimed in claim 2, wherein, at the two ends of the rib, the electronic label has two end-plates that guide the rib into the groove and hold the electronic label in place by collaborating with the vertical edges of the front part of the label holder.
